(19) United States
(12) Patent Application Publication
(10) Pub. No.: US 2009/0109289 A1
(43) Pub. Date: Apr. 30, 2009

(54) Voice enhanced closed circuit TV system

(76) Inventor: Bradley W. Gordon, Newton, MA (US)

Correspondence Address: ALIX YALE & RISTAS LLP, 750 MAIN STREET, SUITE 1400, HARTFORD, CT, 06103, US

(21) Appl. No.: 11/978,359

(22) Filed: Oct. 29, 2007

(51) Int. Cl. H04N 7/18

(52) U.S. Cl. 348/153; 348/E07.086

(57) ABSTRACT

A system and device that enables a security officer on site or an agent in a remote central station, to speak to, and optionally receive speech from, a potential intruder observed or otherwise detected in the field of view of a particular one of a multiplicity of surveillance cameras at the site. This is achieved by locating speakers and optionally microphones at each camera, and locating an audio unit at the camera head unit in communication with the speakers, by which the security officer or central station agent can select and speak through a particular speaker, thereby warding off an intruder who is near the particular camera. If the speech communication is two-way, the officer or agent can interrogate the potential intruder to determine if access to the site is authorized. The audio unit is configured for integration with many types of surveillance systems, and is particularly advantageous for routing an audio signal originating at a remote central station agent to a speaker associated with a particular camera.

### BACKGROUND

The present invention relates to surveillance systems, and particularly to multi-camera closed circuit video systems.

Modern property surveillance systems, especially for commercial or institutional sites, typically have multiple TV or video cameras distributed throughout the site to monitor activity inside and/or outside buildings on the site. All the cameras at a given site deliver image signals to a head unit on the site. Commercial grade surveillance/security CCTV systems allow a user to view one or all of the cameras on the system simultaneously via imbedded local and remote view software in the head unit at the head end of the system. The head unit can be implemented by DVR, DVMR, or NVR devices, in digital or analog, form.

In a relatively simple system, the head unit or other processor is connected to a display panel on or offsite, where a security officer can observe the field of view of each camera and take appropriate action in the event of an unusual occurrence.

In a more comprehensive system, a surveillance agency at a central location receives inputs from the head units of multiple sites, and displays images on one or more panels, where an agent can observe suspicious activity or deviations derived from intermediate intelligence processing. Upon observing a predetermined level of deviation from “normal” conditions in the field of view of a particular camera at a particular site, the agent can call the security officer for the site, or initiate a general site alarm or an alarm associated with a particular camera.

Systems of the type described above are available in a DVR platform from PELCO (DX8100), American Dynamics (Intellex DVMS), Dedicated Micros (Digital Esprite), or GANZ (Triplex). In these systems, the security officer or agent can send a control signal to the head unit by which a particular camera can be panned or angulated, and/or an alarm activated.

### SUMMARY

The systems described above do not permit the security officer on site or the agent in the central station, to speak to a potential intruder observed in the field of view of a particular camera.

It is an object of the present invention, to enable a security officer on site or an agent in a central station, to speak to, and optionally receive speech from, a potential intruder observed or otherwise detected in the field of view of a particular camera.

This object is achieved by locating speakers and optionally microphones at each camera, and locating an audio unit at the head unit in communication with the speakers, by which the security officer or central station agent can select and speak through a particular speaker, thereby warding off an intruder who is near the particular camera. If the speech communication is two-way, the officer or agent can interrogate the potential intruder to determine if access to the site is authorized.

The audio unit is configured for particularly advantageous use in routing an audio signal originating at a remote central station agent to a speaker associated with a particular camera.

By adding the audio unit to existing systems, the user of any major manufacturer's intelligent video systems has the ability to speak and/or listen from any or all camera locations within the particular facility represented on a panel display such that the user can easily choose the location at which to speak and/or listen while either on site or from any remote monitoring location.

The audio unit is multiplatform because it integrates with intelligent video systems of all major manufacturers, and the size of the system is not a limitation because multiple audio units can be used in tandem to provide unlimited audio channels. A standard audio unit of the type disclosed herein preferably has 16 channels of bi-directional audio (most major manufacturers of intelligent video have standardized their units with 16 channels of video) but can be built with an unlimited number of channels.

In the most useful embodiment, the central station agent activates an alarm out signal from the head unit using the pre-existing software and graphic user interface (GUI) in one of several major manufacturers' CCTV systems. This signal is transferred over a hard wired connection to corresponding relay inputs on the audio unit. The inputs to the audio unit manipulate the state of a relay bank to direct the audio received via a separate analog or digital input to a pre-determined channel, which has a corresponding audio device (e.g. loudspeaker) in the field.

The audio unit preferably has a multichannel input corresponding to the number of cameras that deliver signals to the head unit, and a multichannel output corresponding to the number of speakers (which in general has a one-to one correspondence with the cameras). The problem to be overcome, is that the officer or agent will send a speech (audio) signal through one line originating at the panel, but that speech signal must be routed through the audio unit to the desired camera/speaker. This is preferably accomplished by a logic circuit that receives a channel-dependent signal from the head unit, and enables a signal path to the corresponding channel for the selected speaker. The logic in the audio unit preferably has a relay input for each camera connected to the head unit and an audio output to each speaker associated with a camera. The audio signal from the panel enters the audio unit where the logic circuit directs the audio signal to the particular/selected speaker.

Preferably, a bi-directional communications processor receives the speech signal from the officer or agent, directs it to the enabled speaker, receives the speech signal from a microphone associated with that speaker, and directs it back to the officer or agent. The officer or agent operates on any convenient from of voice communication, either digital or analog, such as telephone or Internet. Digital signals would require digital to analog conversion to the speaker and analog to digital conversion from the microphone in a bi-directional system. This is accomplished using well-known techniques.

Before installation on site, an audio unit of this kind comprises a multi-channel array of hardwired input signal terminals, a multi-channel array of hardwired voice output terminals corresponding respectively to the array of input terminals, and a voice communications circuit operatively connected to relays between the input terminals and the output terminals. A bank of relays is respectively connected to the array of input terminals and output terminals such that an input signal on a given input terminal activates one relay that electrically connects the communications circuit to one of the audio output terminals. A voice input terminal is provided for the voice communications circuit, whereby a user who initiates an input signal on a given input signal terminal enables a voice communications path from the voice input terminal to the unique voice output terminal.

On site, a conductor is extended from each output terminal to a respective remote speaker, and a voice communications device such as a telephone line is connected to the voice communications circuit. The audio unit is connected to the head unit whereby the officer or agent can initiate a signal through the head unit for selectively delivering an input signal to only one of the input signal terminals on the audio unit, enabling him or her to speak at the location of a particular camera.

In the comprehensive system embodiment, one agent at the central station can observe one or more panels, with each panel displaying an image of the field of view of all cameras at a particular site. When a deviation is observed at one camera, the agent can send an alarm signal along the same communications path that carries the individual camera control signal to the head unit. However, in the head unit this alarm signal is directed via a different channel dependent output port of the head unit, to the audio unit.

### BRIEF DESCRIPTION OF THE DRAWING

Exemplary embodiments are described below with reference to the accompanying drawing, in which:

FIG. 1 is a block diagram of a comprehensive surveillance system incorporating an embodiment of the invention;

FIG. 2 is a schematic of the external connections for an audio unit having 16 channels;

FIG. 3 is a circuit diagram of the audio unit of FIG. 2; and

FIG. 4 is a schematic of another system implementation.

### DETAILED DESCRIPTION

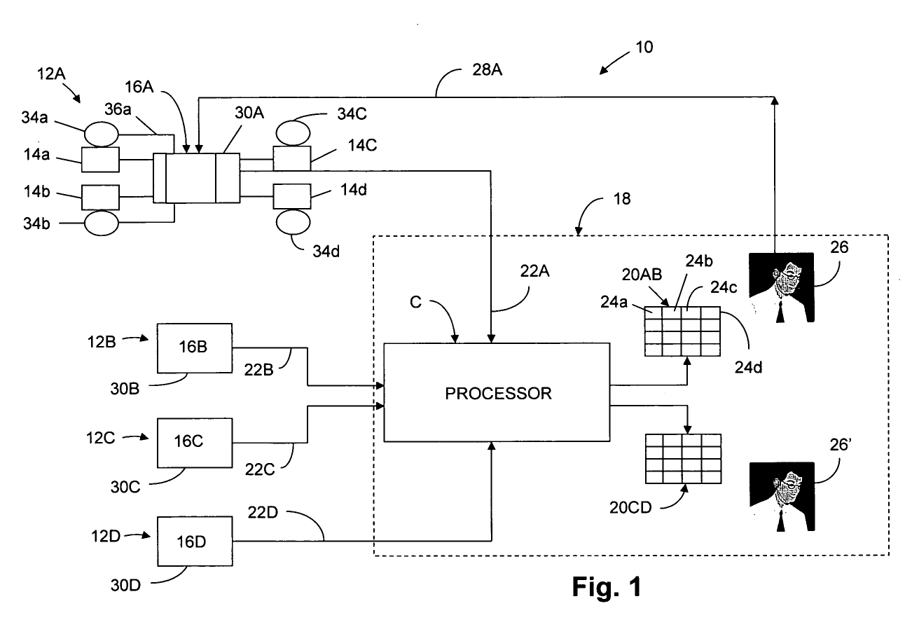

FIG. 1 shows a comprehensive surveillance system 10 comprising a multiplicity (but showing only four) site monitoring systems 12a, 12b, 12c, 12d located at a respective plurality of sites that are remote from each other. Each site monitoring system has a plurality (but showing only four) video cameras 14a, 14b, 14c, 14d distributed throughout the site and a head unit such as 16a, 16b, 16c, 16d to which each camera delivers a video signal carrying an image of the field of view of the camera.

A central station 18 is located remotely from but in communication with the head units at all the sites. A computer or similar digital processing system C receives signals via lines 22a, 22b, 22c, 22d from the head units 16 and presents associated information on a plurality (but only showing two) display panels 20a,b, 20c,d. A display panel for a given head unit 16a displays an image 24a, 24b, 24c, 24d of the field of view of each camera 14a, 14b, 14c, 14d associated with the given head unit 16a, whereby an agent 26 at the panel can observe the field of view of each camera at a particular site. One agent may observe more than one panel; a given panel may display images from more than one site; and one or more additional agents 26′ may be in the central station.

A signal path 28a (others not shown) is established from the central station to each head unit, such as 16a. This signal path provides for the agent to select any one camera, such as 14a, from among the plurality of cameras associated with the given head unit, for controlling zoom, pan, or the like. Signal paths 22 and 28 can be distinct, or common, with bidirectional bandwidth. The paths need not be visible, in that a universal communications network (Internet) or proprietary intranet can be employed for this purpose. The head unit 16 at each site has an input option for receiving alarm selection signals generated from the central station, and corresponding alarm output terminals for outputting respective alarm signals.

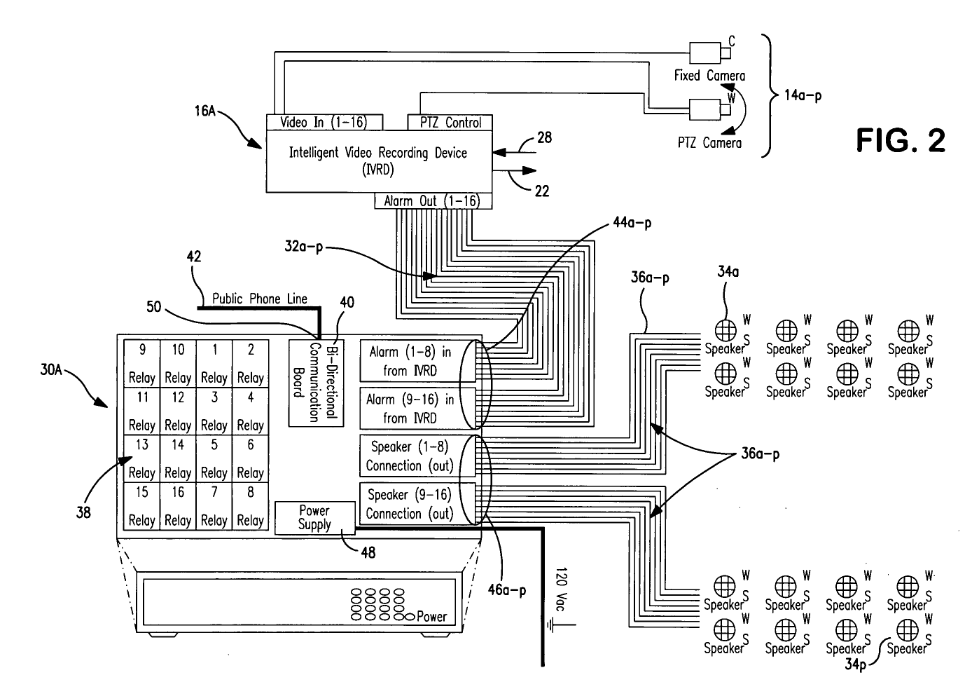

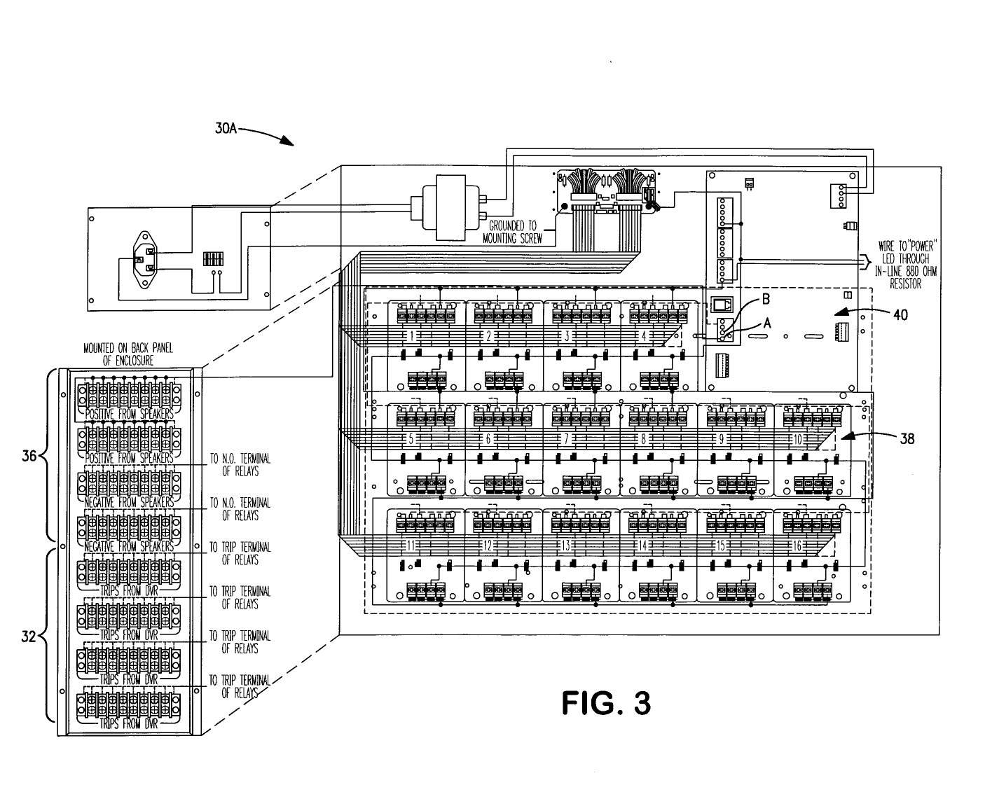

As shown in FIGS. 2 and 3, the present disclosure is directed to an audio unit such as 30a, by which the agent or other user has the ability to speak and/or listen via speakers and/or microphones from any or all camera locations within the particular facility represented on the panel display such that the user can easily choose the site/location to speak and or listen while either on site or at any remote monitoring location. In FIG. 1, only four of the cameras 14a-14d and associated speakers 34a-34d are shown, whereas FIG. 2 shows the full, preferred implementation of a 16 channel audio unit with 16 associated cameras (14a-p) and speakers (34a-p).

Each audio unit such as 30a at site 12a is in communication with the respective head unit such as 16a at that site, for receiving a signal 32a-p from the head unit, commensurate with the agent's selection of a particular camera 14 a-p at the particular site. In this context, “commensurate” means related physically, logically or by intention. An audio speaker 34a-p is mounted in proximity to each camera 14a-p at each site. An audio communication path 36a-p is present from the audio unit to each respective speaker.

A logic circuit 38 in the audio unit is responsive to the particular one of the alarm/control signals 32a-p commensurate with the agent's selection of a particular camera for enabling an audio communications path to a speaker such as 34a in proximity to the selected camera such as 14a. A voice communications circuit 40 in the audio unit, receives speech on line 42 from the agent and delivers this speech through the enabled communications path such as 36a to the speaker 34a in proximity to the selected camera 14a. A conductor 36a-p is attached to each output terminal 46a-p and to a respective remote speaker 34a-p. Microphones can be electrically connected respectively to the conductors 36a-p that are attached to each output terminal 46 a-p and to a respective remote speaker 34a-p. Alternatively, speakers that also serve as microphones can be employed.

The audio unit 30a at each site has input terminals 44 a-p hardwired to the alarm output terminals of the respective head unit 16a, for receiving an alarm signal 32a-p from the head unit commensurate with the agent's selection of a particular camera at a particular site and delivering the alarm signal as an input to the logic circuit 38. The logic circuit is preferably a bank of 16 relays. In this manner, the generation of a particular alarm selection signal at the central station is transmitted through the head unit to the audio unit, enabling delivery of the agent's speech through the enabled communications path 36a to the speaker 34a in proximity to the selected camera 14a.

Preferably, the audio unit 30 comprises a multi-channel array of hardwired input signal terminals 44a-p, and a multi-channel array of hardwired audio output terminals 46a-p corresponding respectively to the array of input terminals. The bank of relays 38a-p are respectively connected to the array of input terminals 44a-p and output terminals 46a-p such that an input signal 32a on a given input terminal 44a activates one relay 38a that electrically connects the communications circuit 40 to a unique one of the voice output terminals 46a.

A audio input terminal 50, such as a telephone jack, provides the input path to the voice communications circuit. The voice communications circuit is any conventional, bi-directional circuit board. A user who initiates an input signal 32a on a given input signal terminal 44a enables a voice communications path from the voice input terminal to a unique voice output terminal 46a.

The communications circuit 40 is connected to one leg of the output side of each relay 38a-p, and the other output leg of each relay is connected to one of the output terminals 46a-p. The input side of each relay is connected to one of the alarm signal input terminals 44a-p. In this manner when a particular relay such as 38a is closed as a result of receiving a signal 32a through terminal 44a, the communications board 40 is electrically connected only to the output terminal 46a for voice communication over conductor 36a with speaker 34a The audio unit 30 requires a source of electrical power for the relays and communications circuit. The power source can be a conventional power supply 48 in the audio unit and power cord for plugging into a 120V AC socket. Alternatively, the head unit has a power supply and the power supply of the audio unit is connected to the power supply of the head unit.

As previously mentioned, the conventional head unit at each site typically has an input option for receiving alarm selection signals generated from the central station, and corresponding alarm output terminals for outputting respective alarm signals. If the head unit has only one set of alarm out terminals, these can be used for the audio feature as a replacement for, e.g., a flashing alarm feature. The alarm signal may be used to trip more than one relay, e.g., alarm and the logic relay in audio unit. The audio unit delivers the alarm signal as an input to the logic circuit, enabling the delivery of the agent's speech through the enabled communications path 36a to the speaker 34a in proximity to the selected camera 14a.

Although the foregoing description is illustrative of the agent selecting one speaker 34a associated with one camera 14a for speaking to a potential intruder, one of ordinary skill in electromechanical devices can adapt the audio unit to enable a plurality of communications paths 32a,b; 36a,b; 38a,b; for the bidirectional functionality of the communications circuit 40 with a corresponding plurality of speakers 34a,b.

FIG. 3 shows a detailed circuit diagram of one implementation of the audio unit. The relays in the middle are activated when selecting an output relay from the graphic user interface of the IVRD. The output relay #1 from the IVRD is hardwired to DVR trips in on the audio unit. The DVR trips screw terminal in is an extension of the circuitry internal to the audio unit and it is terminated on the corresponding relay internally. Once the signal is sent from the IVRD to the DVR trips in terminals and received by the internal relay, the coil on the relay is activated causing a closure on the output side of the chosen relay and thus allows audio to be passed out to the speaker. The sole function of the bi-directional communications circuit is to provide inbound audio (telephone connection) to the audio unit. The selection of an audio channel is through the relay logic and the graphic user interface of the existing CCTV platform.

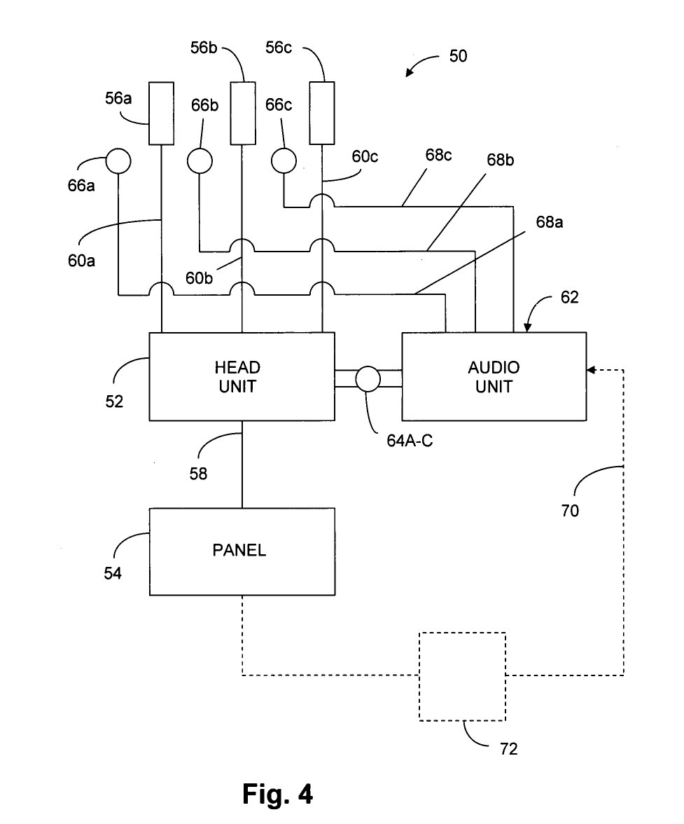

FIG. 4 shows a surveillance system implementation 50 that is dedicated to a single site. The head unit 52 is in communication with the on-site panel 54. The security officer observes the fields of view of the cameras 56a-c (only three shown) and can control camera movements, from the panel 54 through communications line 58 to the head unit 52 and associated camera connections 60a-c. As in the system shown in FIGS. 2 and 3, an audio unit 62 receives a camera specific alarm out signal on one of the lines 64a-c from the panel 54 via the head unit 52. The audio unit logic enables delivery of a voice signal to a particular speaker such as 66a associated with a particular camera 56a, via line 68a. The voice can be directed to any of the other speakers 66b,c via respective lines 68b,c. The voice originates on (for example phone) line 70 from the panel 54 or from a remote viewing station 72 in communication with the panel and is not channeled before delivery to the audio unit.

1. A surveillance system comprising:
a plurality of site monitoring systems located at a respective plurality of sites that are remote from each other;
each site monitoring system having a plurality of video cameras distributed throughout the site and a head unit to which each camera delivers a video signal carrying an image of the field of view of the camera;
a central station located remotely from all said sites, said central station having a plurality of display panels in communication with a respective plurality of head units;
wherein a display panel for a given head unit displays an image of the field of view of each camera associated with the given head unit, whereby an agent at the panel can observe the field of view of each camera at a particular site;
a signal path from the central station to each head unit, said signal path enabling the agent to select any one camera from among the plurality of cameras associated with a given head unit;
an audio unit at each site, in communication with the respective head unit at each site, for receiving a signal from the head unit commensurate with the agent's selection of a particular camera at a particular site;
an audio speaker mounted in proximity to each camera at each site;
an audio communication path from the audio unit to each speaker;
a logic circuit in the audio unit responsive to the signal commensurate with the agent's selection of a particular camera for enabling only the audio communications path to the speaker in proximity to the selected camera;
a voice communications circuit in the audio unit, for receiving speech from the agent and delivering this speech through the enabled communications path to the speaker in proximity to the selected camera.

2. The system of claim 1, wherein
the head unit at each site has an input for receiving alarm selection signals generated from the central station, and corresponding alarm output terminals for outputting respective alarm signals;
the audio unit at each site has input conductors hardwired to the alarm output terminals of the respective head unit, for receiving an alarm signal from the head unit commensurate with the agent's selection of a particular camera at a particular site and delivering the alarm signal as an input to the logic circuit;
whereby the generation of a particular alarm selection signal at the central station is transmitted through the head unit to the audio unit, enabling the delivery of the agent's speech through the enabled communications path to the speaker in proximity to the selected camera.

3. An audio unit comprising:
a multi-channel array of hardwired input signal terminals;
a multi-channel array of hardwired voice output terminals corresponding respectively to the array of input terminals;
a voice communications circuit;
an array of relays respectively connected to the array of input terminals and output terminals such that an input signal on a given input terminal activates one relay that electrically connects the communications circuit to a unique one of the voice output terminals;
a power input source for the relays and communications circuit; and
a voice input terminal to the voice communications circuit;
whereby a user who initiates an input signal on said given input signal terminal enables a voice communications path from the voice input terminal to said unique voice output terminal.

4. The audio unit of claim 3, wherein the communications circuit is bi-directional.

5. The audio unit of claim 3, wherein a conductor is attached to each output terminal and to a respective remote speaker.

6. The audio unit of claim 4, wherein microphones are electrically connected to the conductors that are attached to each output terminal.

7. The audio unit of claim 3, wherein each multi-channel array has 16 channels and the array of relays has 16 sets of relays.

8. The audio unit of claim 3, wherein the voice input terminal is a telephone jack.

9. The audio unit of claim 3, wherein
the audio device is at a head unit of a closed circuit video surveillance system having multiple cameras individually controlled through said head unit;
the number of channels in said multi-channel array of hardwired input signal terminals corresponds to the number of cameras;
a conductor is attached to each output terminal and to a remote speaker located at each camera; and
said head unit selectively delivers an input signal to only one of said input signal terminals.

10. The audio unit of claim 3, wherein the power source is power supply unit and a power chord for plugging into a 120V AC socket.

11. The audio unit of claim 9, wherein the head unit has a power supply and the power input of the audio unit is connected to the power supply of the head unit.

12. The audio unit of claim 9, wherein the head unit at each site has an input for receiving alarm selection signals generated from the central station, and corresponding alarm output terminals for outputting respective alarm signals;
the audio unit at each site has input conductors hardwired to the alarm output terminals of the respective head unit, for receiving an alarm signal from the head unit commensurate with the agent's selection of a particular camera at a particular site and delivering the alarm signal as an input to the logic circuit;
whereby the generation of a particular alarm selection signal at the central station is transmitted through the head unit to the audio unit, enabling the delivery of the agent's speech through the enabled communications path to the speaker in proximity to the selected camera.
